(19) United States
(12) Patent Application Publication
(10) Pub. No.: US 2026/0233841 A1
(43) Pub. Date: Aug. 13, 2026

(54) SEAT DEVICE

(71) Applicants: TOYOTA BOSHOKU KABUSHIKI KAISHA, Aichi-ken (JP); JAPAN AEROSPACE EXPLORATION AGENCY, Tokyo (JP)

(72) Inventors: Takashi SAITO, Aichi-ken (JP); Hitoshi YASUDA, Nagoya-shi (JP); Yuka KAWAKAMI, Toyota-shi (JP); Konomi FUMOTO, Toyota-shi (JP); Tetsuo YASUOKA, Tokyo (JP); Yuki KISHI, Tokyo (JP); Tokuaki NAKAJIMA, Tokyo (JP)

(73) Assignees: TOYOTA BOSHOKU KABUSHIKI KAISHA, Aichi-ken (JP); JAPAN AEROSPACE EXPLORATION AGENCY, Tokyo (JP)

(21) Appl. No.: 19/457,755

(22) Filed: Jan. 23, 2026

(30) Foreign Application Priority Data
Jan. 28, 2025 (JP) 2025-012001

(51) Int. Cl. B64D 11/06

(52) U.S. Cl. CPC B64D 11/0647; B64D 11/064

(57) ABSTRACT

A seat device in which a seat main body provided with a seat cushion serving as a seat portion and a seat back serving as a backrest is arranged in a seat space set at a predetermined arrangement location, the seat device includes wheels configured to allow the seat main body to travel, and a support portion configured to support the seat main body. The support portion is disposed at the arrangement location so as to be disposed below the seat cushion, and the seat main body occupies the seat space by the seat cushion being detachably coupled to and supported by the support portion.

### CROSS-REFERENCE TO RELATED APPLICATIONS

This application is based on and claims priority under 35 USC 119 from Japanese Patent Application No. 2025-012001 filed on Jan. 28, 2025, the entire content of which is incorporated herein by reference.

### TECHNICAL FIELD

The present disclosure relates to a seat device in which a seat main body including a seat cushion and a seat back is arranged in a seat space set in a vehicle interior.

### BACKGROUND ART

In a general vehicle or building, a predetermined number of seats (corresponding to seat main bodies) are arranged in the interior, and one seat occupies a predetermined seat space set in the interior. In the field of this type of seat, there is a demand for the seat to be movable between the seat space and another location, from the viewpoint of ensuring convenience for a seated person. For example, in a technique of WO2021/100032, seats are arranged side by side in an interior of a passenger aircraft. A wheelchair is detachably set on a seating side of a specific seat. In the above technique, the wheelchair can be detached from the seat and moved to another location. In addition, in a technique of JP2021-014134A, seats are slidably coupled to rails laid on a floor portion of a passenger aircraft. In the above technique, rails are laid horizontally across the seats arranged side by side, and further rails are laid vertically along a passage of the vehicle. Accordingly, the seats can be moved horizontally along the horizontal rails and then moved along the vertical rails on the passage.

In general vehicles or the like, when a seat (seat main body) is disposed in a seat space, an appropriate personal space is secured around the seat. However, in the technique of WO2021/100032, the wheelchair is set on the seating side of the seat, and thus the personal space of the seated person seated on the wheelchair is narrowed. Therefore, in the above technique, a wheelchair cannot be used in the same manner as a normal seat, and it is difficult to ensure the convenience during normal seating. It is also conceivable that a part of the seat, that is, a slightly smaller seat portion is divided, and the divided small seat portion is moved. However, the seated person needs to sit on the small seat portion and move, and it is difficult to ensure convenience during movement. In addition, in the technique of JP2021-014134A, the seat itself can be moved, but it is necessary to lay the rails according to a movement distance of the seat, that is, to introduce large-scale equipment. The present disclosure has been made in view of the above problems, and an object of the present disclosure is to move a seat main body itself between a seat space and another location without requiring large-scale equipment.

### SUMMARY OF INVENTION

According to a first aspect of the present disclosure, a seat device in which a seat main body provided with a seat cushion serving as a seat portion and a seat back serving as a backrest is arranged in a seat space set at a predetermined arrangement location is provided. In this type of device configuration, it is desirable that the seat main body itself is moved between the seat space and the other location without requiring large-scale equipment. The seat device includes wheels configured to allow the seat main body to travel, and a support portion configured to support the seat main body. The support portion is disposed at the arrangement location so as to be disposed below the seat cushion, and the seat main body occupies the seat space by the seat cushion being detachably coupled to and supported by the support portion. In the present disclosure, a support portion that supports the seat main body is provided below a seat cushion, that is, a location different from the seat space in which the seat cushion and the like are disposed. Therefore, the seat main body can be disposed such that the seat cushion and a seat back occupy the seat space, and can be used in the same manner as a normal seat. In the above device configuration, the seat main body with wheels can be moved to the other location by detaching the seat cushion from the support portion, and thus no large-scale equipment is required.

According to a second aspect of the present disclosure, the seat device according to the first aspect, further includes a lifter mechanism configured to displace one of the seat cushion and the support portion between a coupling state in which the one of the seat cushion and the support portion is moved up and down to be coupled to the other and a released state in which the one of the seat cushion and the support portion is separated from the other to release the coupling. In the present disclosure, the seat cushion or the support portion is moved up and down by an operation of a lifter mechanism, so that the seat cushion and the support portion can be brought into a coupling state or a released state.

According to a third aspect of the present disclosure, in the seat device according to the first aspect, the seat back includes a base portion fixed to a side portion in a seat width direction thereof, and a plate-shaped member attached to the base portion via a hinge portion. The plate-shaped member is displaceable between a deployed posture in which the plate-shaped member is tilted outward in the seat width direction and a retraction posture in which the plate-shaped member stands in a seat upper direction by a raising and tilting operation with the hinge portion as a base point. In the present disclosure, when the seat main body is disposed in the seat space, an object can be placed on a plate-shaped member in a deployed posture, which contributes to ensuring convenience. By bringing the plate-shaped member into a retraction posture, a dimension in a seat width direction of the seat main body can be reduced when the seat main body is moved.

According to a fourth aspect of the present disclosure, in the seat device according to first aspect, a cushion portion that elastically supports a seated person is detachably attached to a seating surface side of the seat cushion. In the present disclosure, a cushion portion can be attached to and detached from the seat cushion, which contributes to securing convenience.

According to a fifth aspect of the present disclosure, in the seat device according to the first aspect, the support portion in a state of supporting the seat cushion is provided with an accommodation space portion having a predetermined capacity so as to communicate with an outside. In the present disclosure, an accommodation space portion is provided in the support portion below the seat cushion in a state in which the seat main body is disposed in the seat space, which further contributes to securing convenience.

According to a sixth aspect of the present disclosure, in the seat device according to the first aspect, the support portion extends in a width direction across a plurality of the seat spaces arranged side by side, and includes a movement mechanism that causes the seat main body, which is released from the coupling with the support portion, to horizontally move in the width direction along the support portion. In the present disclosure, the seat main body can be disposed in a desired seat space by causing the seat main body to horizontally move along the support portion by an operation of a movement mechanism.

According to a seventh aspect of the present disclosure, in the seat device according to sixth aspect, the seat main body is provided with a grip portion, which serves as a handle during movement of the seat main body, on an end portion side in a seat width direction. In the present disclosure, the seat main body can be more easily moved horizontally by a grip portion.

According to the first aspect of the present disclosure, a seat main body itself can be moved between a seat space and another location without requiring large-scale equipment. According to the second aspect of the present disclosure, the seat main body can be more reliably moved between the seat space and the other location. According to the third aspect of the present disclosure, the seat main body itself can be moved between the seat space and the other location while ensuring convenience of the seat main body. According to the fourth aspect of the present disclosure, it is possible to further contribute to securing convenience. According to the fifth aspect of the present disclosure, it is possible to further contribute to securing convenience. According to the sixth aspect of the present disclosure, the seat main body itself can be moved between a desired seat space and the other location. According to the seventh aspect of the present disclosure, the seat main body can be moved more easily.

### BRIEF DESCRIPTION OF DRAWINGS

FIG. 1 is a schematic perspective view of a part of a vehicle interior illustrating seat devices;

FIG. 2 is a transparent schematic perspective view of a part of a seat main body;

FIG. 3 is a transparent schematic side view of the seat device illustrating the seat main body in a see-through manner;

FIG. 4 is an enlarged schematic perspective view of a rear portion of the seat device illustrating a stopper;

FIG. 5 is an enlarged schematic perspective view of a front portion of the seat device illustrating foot steps;

FIG. 6 is an enlarged schematic perspective view of the seat main body illustrating a plate-shaped member;

FIG. 7 is a schematic perspective view of a part of a support portion as viewed from a front side;

FIG. 8 is a schematic perspective view of a part of the support portion as viewed from a width direction of the interior;

FIG. 9 is a schematic view illustrating a coupling state between a seat cushion and the support portion;

FIG. 10 is a schematic perspective view illustrating the seat device during movement of the seat main body;

FIG. 11 is a schematic side view of the seat device in an initial stage of movement operation; and

FIG. 12 is a schematic perspective view illustrating the seat device when the seat main body is disposed.

### DESCRIPTION OF EMBODIMENTS

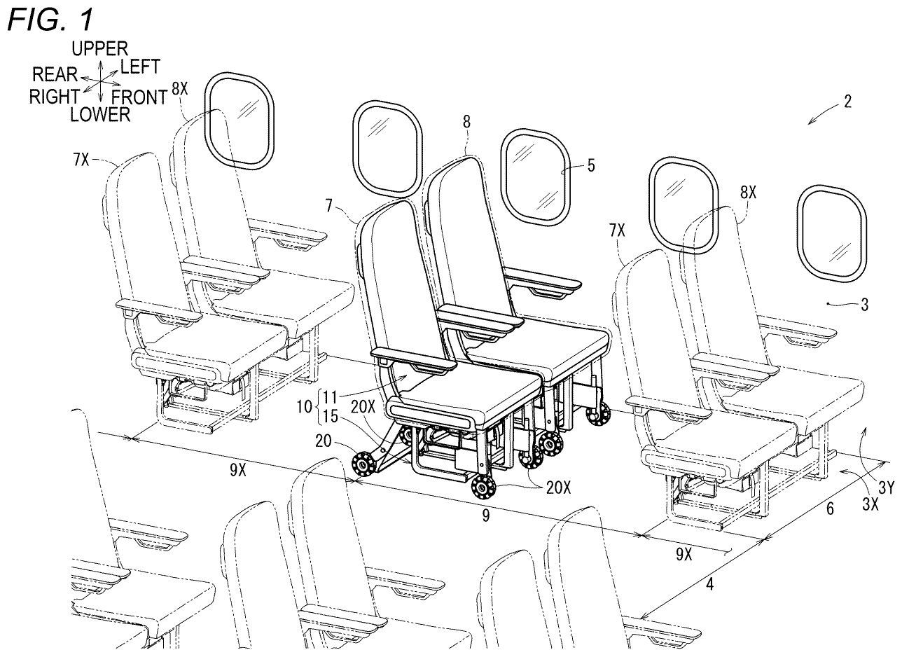

Hereinafter, an embodiment of the present disclosure will be described with reference to FIGS. 1 to 12. In each of the drawings, arrows indicating a front-rear direction, an up-down direction (height direction), and a left-right direction (width direction of a vehicle) with respect to seat devices arranged in the vehicle are appropriately illustrated. For convenience, FIG. 1 mainly illustrates a right side portion of the vehicle, and only members arranged on a right side and a passage portion are denoted by reference numerals.

### Outline of Vehicle Interior

First, a passenger aircraft illustrated in FIG. 1 is taken as an example of a vehicle 2, and an outline of a vehicle interior 3 thereof will be described. A passage portion 4 is formed at a center in a width direction (left-right direction) of a floor portion 3X of the vehicle interior 3 so as to extend in the front-rear direction. In addition, a plurality of window portions 5 are provided at appropriate intervals in left and right side wall portions 3Y of the vehicle interior 3 (in FIG. 1, only a part of the window portions 5 are denoted by corresponding reference numerals). Areas for passenger (passenger areas 6) are provided on both left and right sides of the passage portion 4 so as to be substantially symmetrical. In the passenger area 6, a plurality of seats, each including a seat portion and a backrest, can be arranged side by side vertically and horizontally (in FIG. 1, for convenience, only one seat (seat main body 11 to be described later) is denoted by a reference numeral). That is, in the passenger area 6, seat spaces (seat spaces 7 and 8 or the like, which will be described later) are arranged vertically and horizontally (in FIG. 1, for convenience, a part of the seat spaces are denoted by corresponding reference numerals, and the other seat spaces are denoted by common reference numerals 7X and 8X).

### Arrangement Manner of Seats

Here, in the passenger area 6 illustrated in FIG. 1, seat sections 9 (predetermined arrangement locations) including a plurality of seat spaces or a single seat space can be arranged at the front and rear of the vehicle 2 (in FIG. 1, for convenience, a part of the seat sections are denoted by corresponding reference numerals, and the other seat sections are denoted by common reference numerals 9X). In the seat section 9 and the like of the present embodiment, a plurality of seat spaces 7 and 8 are set side by side so as to be arranged in the width direction (left-right direction) of the vehicle 2. Therefore, in the seat section 9 and the like, seats (seat main bodies 11 and the like) can be arranged in the seat space 7 and the like on a passage side and the seat space 8 and the like on a window side. In the seat section 9 and the like, one seat is disposed for each seat space, and thus an appropriate personal space is secured around the seat.

### Seat Device

In the field of the vehicle 2 and the like illustrated in FIG. 1, there is a demand for the seat (seat main body 11) to be movable between the seat space and another location without requiring large-scale equipment as described above. Therefore, the seat device 10 of the present embodiment includes the seat main body 11, a support portion 15, and the like, which will be described later, so that the seat main body 11 itself is moved without requiring large-scale equipment. Hereinafter, the configuration of the seat device 10 will be described in detail in the order of the seat main body 11 and the support portion 15.

### Seat Main Body

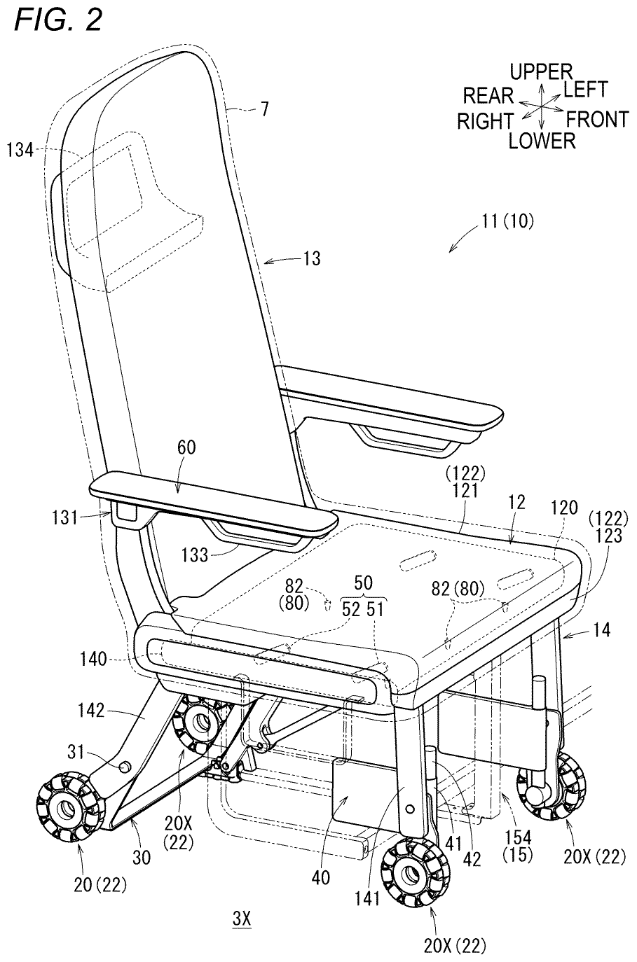

The seat device 10 illustrated in FIG. 2 includes the seat main body 11 on which a seated person can sit. The seat main body 11 includes a seat cushion 12 serving as a seat portion, a seat back 13 serving as a backrest, and a leg portion 14 that supports the seat cushion 12 (details of the members will be described later). In the seat main body 11, the seat cushion 12 extends substantially in the front-rear direction in a side view, and a lower portion of the seat back 13 in an upright state is coupled to a rear portion side of the seat cushion 12. Here, outer dimensions of the seat cushion 12 and the seat back 13 are not particularly limited, but in the present embodiment, the outer dimensions are set to be substantially the same as outer dimensions of a normal seat (for example, a fixed seat indicated by a broken line in FIG. 1). Therefore, in the seat main body 11, the seat cushion 12 and the seat back 13 can occupy the corresponding seat space 7 (8), in the same manner as the normal seat.

### Seat Cushion

The seat cushion 12 illustrated in FIG. 2 includes a seat frame 120 serving as a framework thereof, and an upper layer cushion portion 121 and a lower layer cushion portion 123 that elastically support the seated person. Here, the seat frame 120 is a member having appropriate rigidity, and can support the upper layer cushion portion 121 and the lower layer cushion portion 123 from below. The upper layer cushion portion 121 and the lower layer cushion portion 123 are made of, for example, a foamed resin having an appropriate thickness, and peripheries thereof are covered with a cover material (reference numeral omitted) made of cloth. The upper layer cushion portion 121 is disposed above the lower layer cushion portion 123 to form a seating surface of the seat cushion 12.

The upper layer cushion portion 121 illustrated in FIG. 2 can be detachably attached to the lower layer cushion portion 123. That is, the upper layer cushion portion 121 corresponds to a cushion portion of the present disclosure. This type of detachable structure 122 is not particularly limited, but in the present embodiment, a hooking structure (hooking structure for a member having a fine hook and a member having a fine loop) provided in the upper layer cushion portion 121 and the lower layer cushion portion 123 is adopted. As this type of detachable structure, it is also possible to use a peelable adhesive structure, and a holding structure using a belt or the like. With the above detachable structure 122, various upper layer cushion portions 121 can be selected and attached to the lower layer cushion portion 123 according to preferences of the seated person, and by appropriately selecting upper layer cushion portions 121 with different thicknesses, an eye level of the seated person can be adjusted to match that of other seated persons. In the case of the passenger aircraft or the like, a seated person who wants to use his/her own cushion (not illustrated) to maintain a stable seat can detach the upper layer cushion portion 121, attach his/her own cushion, and stay in that state from boarding to landing.

### Leg Portion

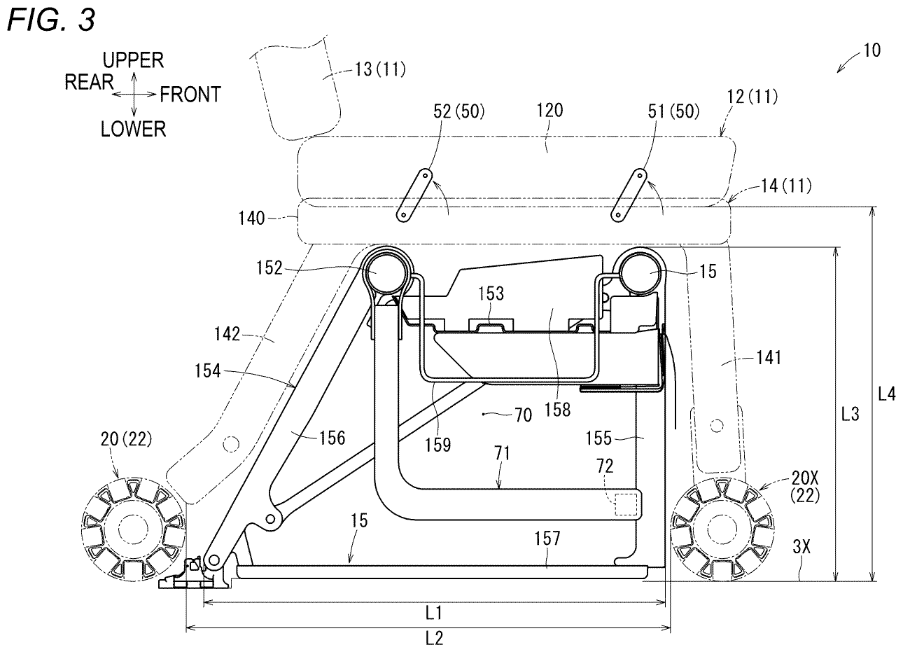

The seat cushion 12 illustrated in FIG. 2 is supported by the leg portion 14, and thus the seat cushion 12 is disposed at a predetermined height position from the floor portion 3X (in each of the drawings, for convenience, when there are a pair of left and right members, only the right member is denoted by a corresponding reference numeral). With reference to FIGS. 2 and 3, the leg portion 14 includes a support frame portion 140 that supports the seat frame 120, a pair of left and right front leg portions 141, and a pair of left and right rear leg portions 142. The pair of left and right front leg portions 141 linearly extend substantially toward a seat lower side from the left and right front ends of the support frame portion 140. The pair of left and right rear leg portions 142 extend substantially obliquely rearward and toward the seat lower side from the left and right rear ends of the support frame portion 140, and lower end portions thereof are disposed at a most seat rear side. The leg portion 14 is provided with wheels 20 (20X), movement mechanisms 22, a stopper 30, and foot steps 40 with a related configuration of the seat main body 11 illustrated in FIG. 2.

### Wheel

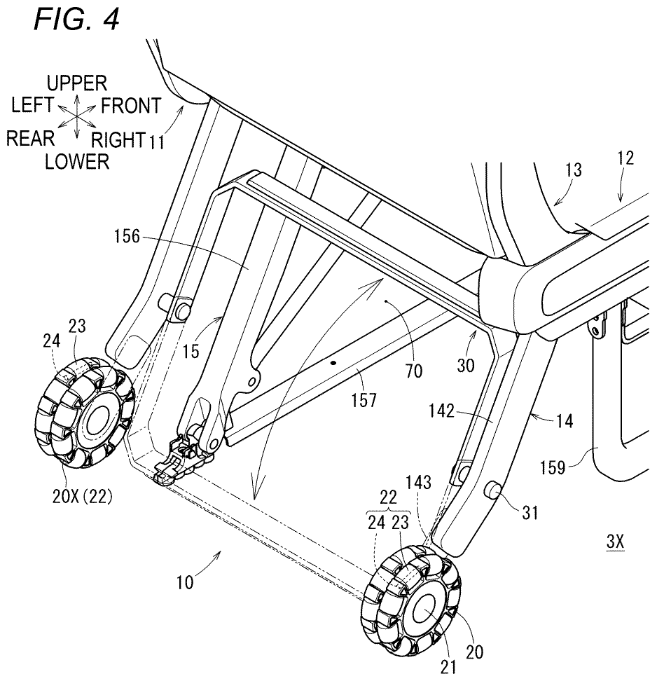

With reference to FIG. 2, the wheels 20 and the like are pivotally supported by the left and right front leg portions 141 and the left and right rear leg portions 142 of the leg portion 14 (in each of the drawings, for convenience, only one wheel 20 is denoted by a corresponding reference numeral in detail, and the other wheels are denoted by a common reference numeral 20X). The seat main body 11 can travel in an appropriate direction by providing the wheels 20 on the left and right front leg portions 141 and the left and right rear leg portions 142. Here, the wheel 20 (20X) having the same configuration is pivotally supported on each of the leg portions of the leg portion 14, and thus the details of the wheel 20 of the right rear leg portion 142 will be described below as an example. As illustrated in FIG. 4, the wheel 20 is pivotally supported by a lower end portion (shaft support plate 143 indicated by a broken line) of the rear leg portion 142 via a shaft 21 extending in the seat width direction. The wheels 20 rotate about the shafts 21, allowing the seat main body 11 provided with the wheels 20 to move (travel) in the front-rear direction of the vehicle 2, for example.

### Movement Mechanism

The wheel 20 illustrated in FIG. 4 is an omnidirectional wheel that is driven forward, backward, leftward, rightward, and the like, and is provided with movement mechanisms 22 that cause the seat main body 11 to move (horizontally move) in the width direction of the vehicle 2. That is, a plurality of rollers 23 serving as the movement mechanisms 22 are pivotally supported at substantially equal intervals on a circumferential portion (ground contact surface) of the wheel 20 (in FIG. 4, for convenience, only one roller is denoted by a corresponding reference numeral). The roller 23 is pivotally supported rotatably by a roller shaft 24 provided on the circumferential portion of the wheel 20, and the roller shaft 24 is disposed at an angle of about 90° with respect to the shaft 21. According to the above configuration, the wheel 20 of the seat main body 11 can be smoothly moved horizontally in the width direction (left-right direction) of the vehicle 2 by the rotation of the rollers 23 as the movement mechanisms 22. As the wheel 20 with the movement mechanisms 22, in addition to the wheel 20, a wheel in which a roller shaft is inclined by 45° with respect to the shaft 21, or a turning caster can be exemplified. Unintended movements of the seat main body 11, such as unintended forward and rearward movements, horizontal movement, and horizontal skidding can be stopped by an operation of the stopper 30 to be described later.

### Stopper

In the leg portion 14 illustrated in FIGS. 2 and 4, the stopper 30 that stops the movement of the seat main body 11 is pivotally supported at the left and right rear leg portions 142 (in each of the drawings, for convenience, when there are a pair of left and right members, only the right member is denoted by a corresponding reference numeral). The stopper 30 is formed in a plate shape extending in the seat width direction, and a right end portion and a left end portion thereof are bent toward a seat upper side. Stopper shafts 31 protruding toward a seat inner side are fixed to the left and right rear leg portions 142 at appropriate positions in a height direction thereof. The stopper 30 has ends at the right end portion and the left end portion, which are axially coupled to the corresponding stopper shafts 31 so as to be vertically pivotable. With the above configuration, when the stopper 30 pivots vertically about the stopper shafts 31, the stopper 30 can be displaced between a stop posture lowered toward the seat lower side and a retraction posture raised toward the seat upper side. The stopper 30 in the stop posture is brought into contact with the floor portion 3X of the vehicle interior 3 to stop the movement of the wheels 20, thereby stopping the seat main body 11 at a predetermined position. The stopper 30 can maintain a posture thereof by a locking mechanism (not illustrated), and the locking mechanism can be released manually or automatically. In addition, by providing a turn over spring on a stopper shaft 31 side, the stopper 30 can be biased to a stop posture side during pivoting downward, and can be biased to a retraction posture side during pivoting upward.

### Foot Step

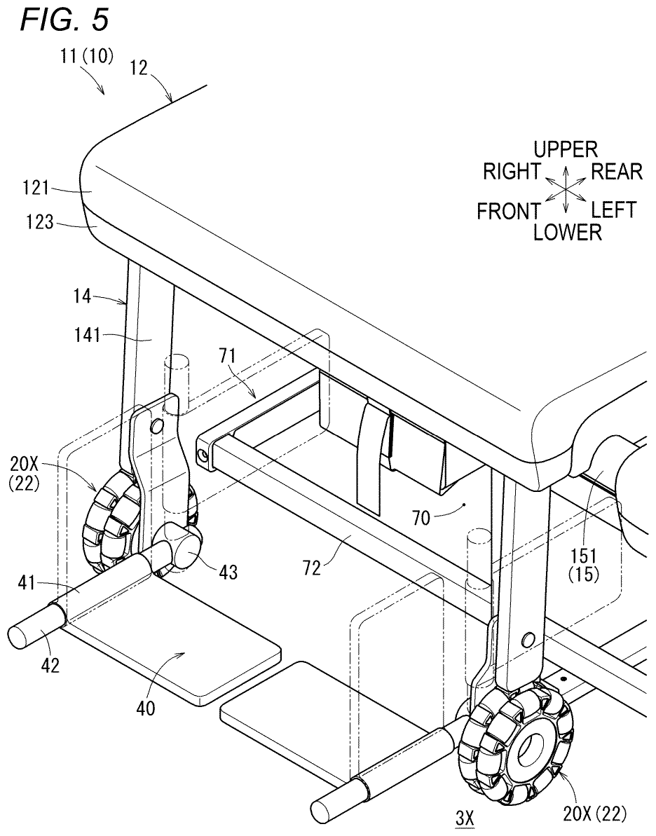

In the leg portion 14 illustrated in FIG. 5, a pair of left and right foot steps 40 that support the feet of the seated person are pivotally supported by the left and right front leg portions 141 (in each of the drawings, for convenience, when there are a pair of left and right members, only the right member is denoted by a corresponding reference numeral). The left and right foot steps 40 are formed of a substantially rectangular plate material, and hollow cylindrical coupling portions 41 are integrally provided on outer sides in the seat width direction. In addition, step bars 42 are pivotally supported at an appropriate height position on the left and right front leg portions 141 via step shafts 43 so as to be raised or lowered. Each of the step bars 42 is inserted into a corresponding coupling portion 41, whereby the foot step 40 provided with the coupling portion 41 is pivotally supported by the corresponding front leg portion 141.

With the above configuration, the left and right foot steps 40 protrude forward of the front leg portions 141 by tilting the left and right step bars 42 illustrated in FIG. 5 forward. Therefore, by pivoting the foot steps 40 downward about the respective step bars 42 and holding the foot steps 40 substantially horizontally, it is possible to bring the foot steps 40 into a footrest posture in which the feet of the seated person can be supported. Conversely, the left and right foot steps 40 are pivoted upward about the respective step bars 42 to stand up, and the step bars 42 are pivoted upward to stand up. Accordingly, the left and right foot steps 40 can be arranged behind the front leg portions 141 and retracted below the seat cushion 12 (see FIG. 2).

### Lifter Mechanism

With reference to FIGS. 2 and 3, the seat main body 11 is provided with a lifter mechanism 50 that raises and lowers the seat cushion 12 (one side) with respect to the support portion 15 (other side) to be described later (in each of the drawings, for convenience, when there are a pair of left and right members, only the right member is denoted by a corresponding reference numeral). Examples of this type of lifter mechanism 50 include various mechanisms such as a four-bar link mechanism, a pantograph mechanism, and an actuator, and in the present embodiment, the four-bar link mechanism is adopted. That is, a front link 51 and a rear link 52 are disposed at left and right positions between the seat frame 120 of the seat cushion 12 and the support frame portion 140 of the leg portion 14 illustrated in FIGS. 2 and 3 (In FIG. 3, for convenience, each of the links is illustrated by a solid line, with the seat main body in a see-through manner). Upper end portions of the front link 51 and the rear link 52 are pivotally supported by the seat frame 120 so as to be vertically pivotable, and lower end portions of the front link 51 and the rear link 52 are pivotally supported by the support frame portion 140 so as to be vertically pivotable.

In the lifter mechanism 50 illustrated in FIG. 2, the front link 51 and the rear link 52 can be raised or lowered with respect to the leg portion 14 by vertical pivoting. As illustrated in FIG. 3, the front link 51 and the rear link 52 are raised, causing the seat cushion 12 to pivot upward with respect to the leg portion 14 and rise. Accordingly, the raised seat cushion 12 is separated upward from the support portion 15 to be described later. As illustrated in FIG. 2, when the front link 51 and the rear link 52 are tilted, the seat cushion 12 pivots downward with respect to the leg portion 14 and is lowered toward the support portion 15 to be described later. The lifter mechanism 50 is provided with a holding mechanism (not illustrated) that holds a position of the links, so that the posture of the links can be maintained, and the links can be pivoted vertically by unlocking the holding mechanism. The four-bar link mechanism can be operated manually or electrically. When the four-bar link mechanism is operated manually, the rising of the seat cushion 12 may be assisted by providing a biasing portion that biases the links in a standing direction.

### Seat Back and Plate-Shaped Member

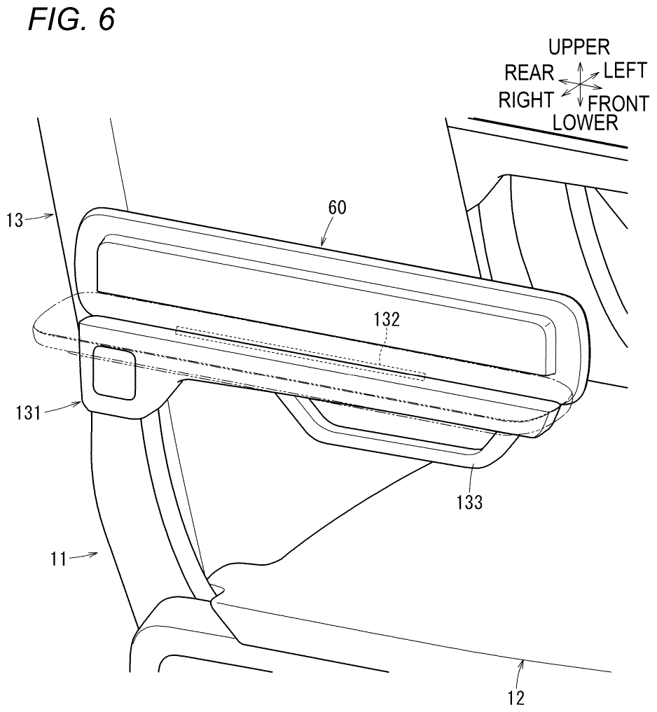

A pair of left and right base portions 131 are fixed to the seat back 13 illustrated in FIG. 2 at positions above the seat cushion 12 (in each of the drawings, for convenience, when there are a pair of left and right members, only the right member is denoted by a corresponding reference numeral). As illustrated in FIG. 6, the base portions 131 are provided on side portions in the seat width direction of the seat back 13, that is, a right side surface and a left side surface of the seat back 13. The base portion 131 is formed in a plate shape extending toward a seat front side, and a rear portion thereof is fixed to a seat back 13 side. A plate-shaped member 60 is attached to an upper end portion of the base portion 131 via a hinge portion 132. The plate-shaped member 60 is formed in a plate shape having an appropriate width dimension (left-right dimension in a tilted state) and extending in the front-rear direction of the seat. The plate-shaped member 60 is displaceable between a deployed posture in which the plate-shaped member 60 is tilted outward in the seat width direction and a retraction posture in which the plate-shaped member 60 stands in a seat upper direction by a raising and tilting operation with the hinge portion 132 as a base point.

### Grip Portion

Grip portions 133 serving as handles are fixed to the base portions 131 of the seat back 13 illustrated in FIGS. 2 and 6 (in FIG. 2, only the grip portion at the left end portion is denoted by a corresponding reference numeral). The grip portion 133 is bent in a substantially U-shape in a side view, and a front end and a rear end thereof are integrated with a lower surface of a front portion of the base portion 131. By providing the grip portion 133 on the base portion 131 located on an end portion in the seat width direction, the grip portion 133 can be used as a handle when the seat main body 11 to be described later moves horizontally. The seat back 13 illustrated in FIG. 2 may be provided with a rear grip portion 134 at an upper portion of a rear surface thereof. The rear grip portion 134 can be used as, for example, a handle when the seat main body 11 is moved (traveled) forward and rearward, for example.

### Support Portion

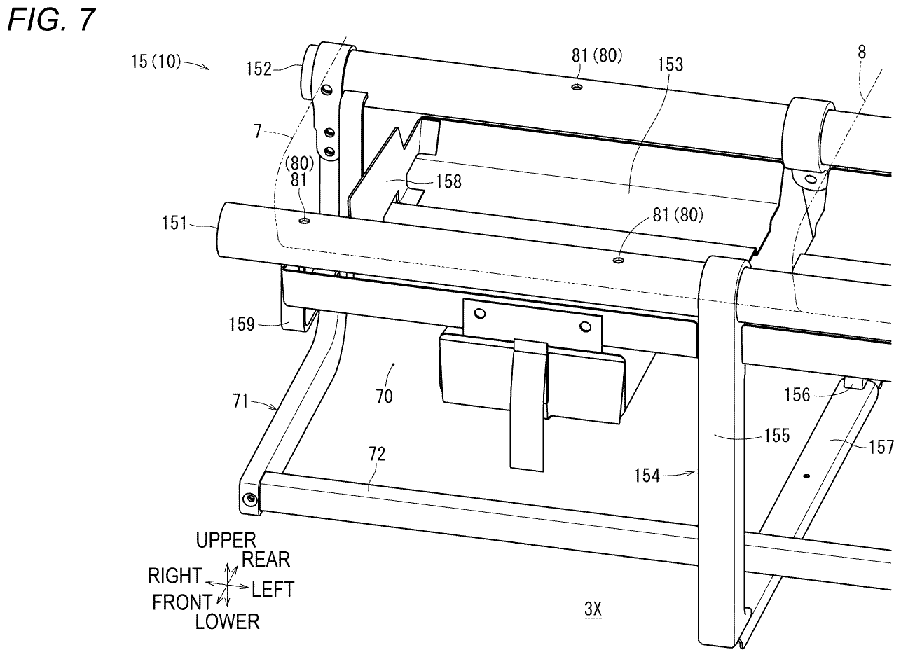

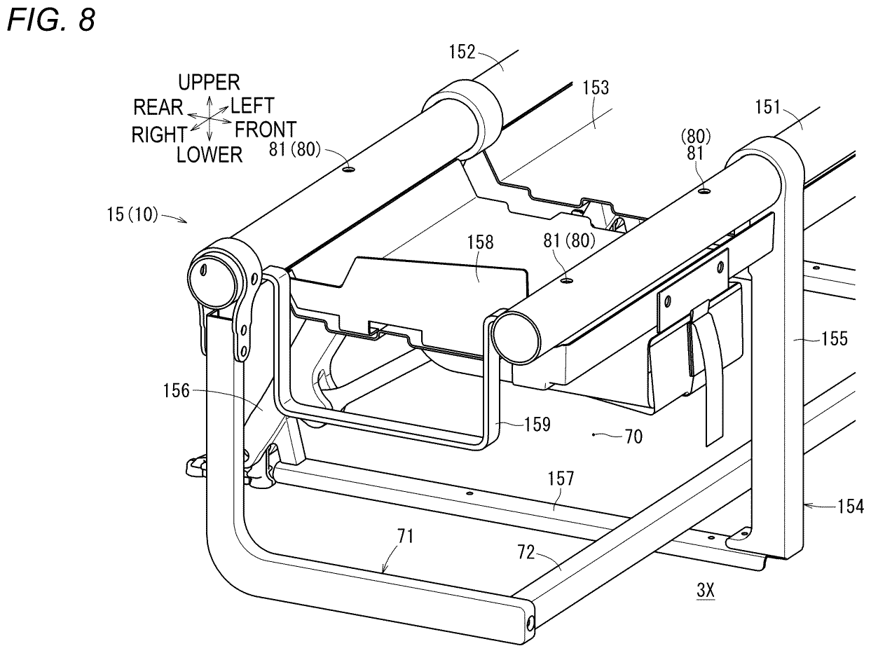

Next, the seat device 10 illustrated in FIG. 1 has a support portion 15 that can support the seat main body 11 from below. With reference to FIGS. 1 and 7, the support portion 15 is disposed on the floor portion 3X of the seat section 9 serving as an arrangement location. The support portion 15 extends in the width direction of the vehicle 2, and crosses the seat space 7 on the passage side and the seat space 8 on the window side. With reference to FIGS. 7 and 8, the support portion 15 includes a pair of front and rear upper support column portions 151 and 152, a top plate portion 153, leg portions 154 that support the upper support column portions, and an accommodation space portion 70 having a predetermined capacity. Here, the pair of front and rear upper support column portions 151 and 152 are each formed in a pipe shape extending in the width direction (left-right direction) of the vehicle 2. In addition, the pair of front and rear upper support column portions 151 and 152 are arranged at an appropriate interval in the front-rear direction of the vehicle 2, and the plate-shaped top plate portion 153 spans and is fixed between the pair of front and rear upper support column portions 151 and 152. The top plate portion 153 is disposed at a position one step lower than the upper support column portions. The pair of front and rear upper support column portions 151 and 152 and the top plate portion 153 extend in the width direction of the vehicle 2, and thus cross the seat space 8 on the window side and the seat space 7 on the passage side.

On the pair of front and rear upper support column portions 151 and 152 illustrated in FIGS. 7 and 8, the leg portions 154 are respectively fixed at appropriate positions in the width direction (in each of the drawings, for convenience, only the leg portion at a central position is illustrated, and the other leg portions (for example, the leg portion at a left end) are not illustrated). The leg portion 154 includes a front leg 155 that spans between the front upper support column portion and the floor portion 3X, and a rear leg 156 that spans between the rear upper support column portion and the floor portion 3X. The front leg 155 extends substantially linearly in a vertical direction, and the rear leg 156 extends obliquely rearward as the same extends downward. A lower leg 157 that spans between lower end portions of the front leg 155 and the rear leg 156 is coupled to and fixed to a rail structure (not illustrated) on a floor portion 3X side. In the support portion 15, the pair of front and rear upper support column portions 151 and 152 are reinforced by the top plate portion 153 and the leg portions 154. Further, the top plate portion 153 is reinforced by a reinforcing plate 158 having a vertical wall shape and provided at an end portion (right end portion) on the passage side. According to the above configuration, the support portion 15 is appropriately reinforced, and a load of the seat main body and the seated person can be stably received by the pair of front and rear upper support column portions 151 and 152. Further, a step portion 159 is provided at an end portion (right end portion) of the pair of front and rear upper support column portions 151 and 152 on the passage side. The step portion 159 is formed in a substantially U shape in a side view, and can be used as a foothold when accessing an overhead luggage space (not illustrated).

### Accommodation Space Portion

In the support portion 15 illustrated in FIGS. 7 and 8, the accommodation space portion 70 capable of accommodating various objects is formed below the top plate portion 153 so as to communicate with an outside. A luggage bar 71 is fixed to the support portion 15 so as to partition the accommodation space portion 70 from the outside. The luggage bar 71 is formed in a columnar shape surrounding a right end, a left end, and a front end of the accommodation space portion 70. That is, a left end portion and a right end portion of the luggage bar 71 are formed in a substantially L shape in a side view, and are disposed at the right end and the left end of the accommodation space portion 70. A front end bar 72 crossing a front of the accommodation space portion 70 spans between front ends of the right end portion and the left end portion of the luggage bar 71 and is fixed thereto.

### Dimensions of Support Portion

With reference to FIG. 3, the support portion 15 has a front-rear dimension L1 of the leg portion 154 that is smaller than a front-rear dimension L2 between the front and rear wheels 20 and 20X (and the leg portions) of the seat main body 11. In addition, the support portion 15 has an upper-lower dimension L3 that is smaller than a dimension L4 of the seat cushion 12 in a raised state and is disposed immediately below the seat cushion 12 in a lowered state. According to the above configuration, by raising the seat cushion 12 with the operation of the lifter mechanism 50, the seat main body 11 is horizontally moved in the width direction (left-right direction) of the vehicle 2 while avoiding interference with the support portion 15 as much as possible.

### Coupling Mechanism

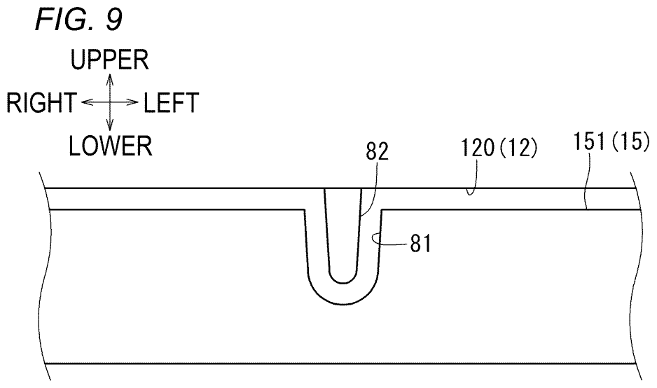

With reference to FIGS. 2 and 7, the seat main body 11 and the support portion 15 are detachably coupled to each other via coupling mechanisms 80. The coupling mechanism 80 can be implemented by a coupling hole portion 81 provided on a support portion 15 side and a coupling protrusion portion 82 provided on a seat cushion 12 side (in each of the drawings, for convenience, each of coupling hole portions is denoted by a common reference numeral, and each of coupling protrusion portions is denoted by a common reference numeral). That is, the support portion 15 is provided with the coupling hole portions 81 at left and right of the front upper support column portion 151, and the coupling hole portion 81 at a center in the width direction of the rear upper support column portion 152. The coupling hole portion 81 is formed in a hole shape that opens to the seat upper side (seat cushion 12 side). In addition, the seat cushion 12 is provided with the coupling protrusion portions 82 at left and right of a front portion of the seat frame 120, and the coupling protrusion portion 82 at a center in the width direction of a rear portion of the seat frame 120. The coupling protrusion portions 82 protrude toward the seat lower side, and face the corresponding coupling hole portions 81 in a state in which the seat main body 11 is disposed in a predetermined seat space. Accordingly, when the coupling protrusion portions 82 are inserted into the corresponding coupling hole portions 81, the seat main body 11 and the support portion 15 are coupled to each other from above and below, as will be described later (see FIG. 9). When the coupling protrusion portions 82 are pulled out from the corresponding coupling hole portions 81, the coupling between the seat main body 11 and the support portion 15 is released.

### Operation of Seat Device

In the vehicle interior 3 illustrated in FIG. 1, the seat main bodies 11 of the seat devices 10 can be arranged in the seat space 7 on the passage side and the seat space 8 on the window side of at least one seat section 9. In the field of this type of vehicle 2 or the like, there is a demand for causing the seat main body 11 serving as a seat to move to a desired location by a simple configuration. Therefore, the seat device 10 includes the wheels 20 (20X) that enable the seat main body 11 to travel, and the support portion 15 that can support the seat main body 11. The support portion 15 is disposed in the vehicle interior 3 so as to be disposed below the seat cushion 12, and the seat main body 11 is arranged so as to occupy the seat space (7 or 8) by the seat cushion 12 being detachably coupled to and supported by the support portion 15. According to the above configuration, the convenience during normal seating and movement of the seat main body 11 can be ensured without requiring large-scale equipment. Therefore, the operation of the seat device 10 will be specifically described below in the order of normal seating and movement of the seat main body.

### Operation of Seat Device During Normal Seating

With reference to FIGS. 1 and 2, the seat main body 11 of the seat device 10 is disposed, for example, in the seat space 7 on the passage side. In the seat device 10 in this state, the support portion 15 is provided below the seat cushion 12, that is, a location different from the seat space 7 in which the seat cushion 12 and the like are to be disposed. Therefore, in the seat main body 11 in the arrangement state, the seat space 7 on the passage side is occupied by the seat cushion 12 and the seat back 13. According to the above configuration, an appropriate personal space is secured around the seat main body 11, and the seat main body 11 can be used in the same manner as the normal seat (for example, a fixed seat), which contributes to securing convenience during normal seating.

In the seat device 10 illustrated in FIG. 2, the convenience during normal seating is secured by various related configurations. For example, in the seat main body 11, the plate-shaped member 60 in the deployed posture can be used as an arm rest that supports an arm of the seated person or a table on which various objects are disposed. In addition, by retracting the foot steps 40 below the seat cushion 12, the seated person on the seat main body 11 can sit with the feet of the seated person on the floor portion 3X. Further, the support portion 15 illustrated in FIG. 3 has appropriate rigidity to maintain an outer shape thereof, and the accommodation space portion 70 is formed below the top plate portion 153. A rear side of the accommodation space portion 70 on which no luggage bar 71 is disposed is in communication with the outside. Therefore, an object is guided and accommodated from a rear seat side in the accommodation space portion 70.

### Operation of Seat Device During Movement of Seat Main Body

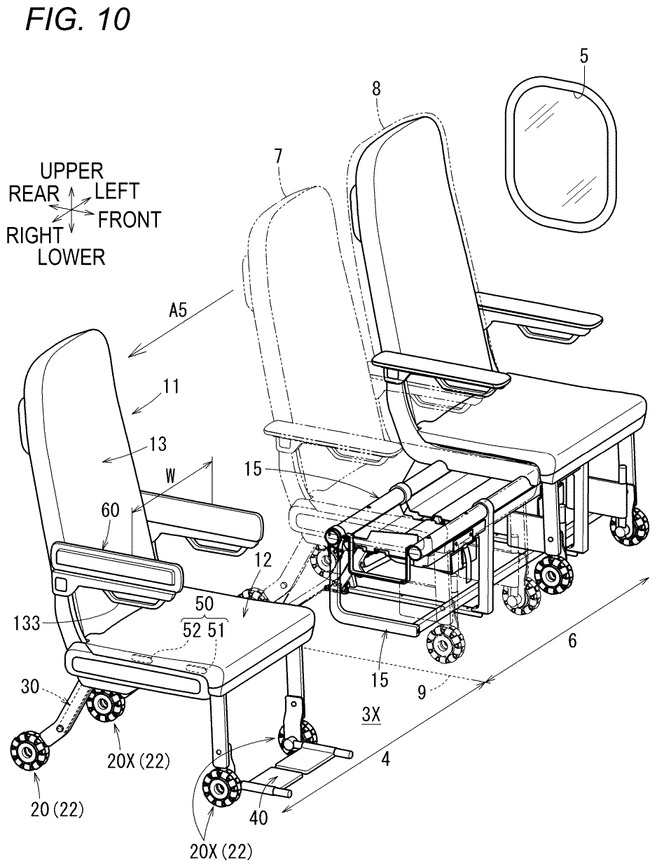

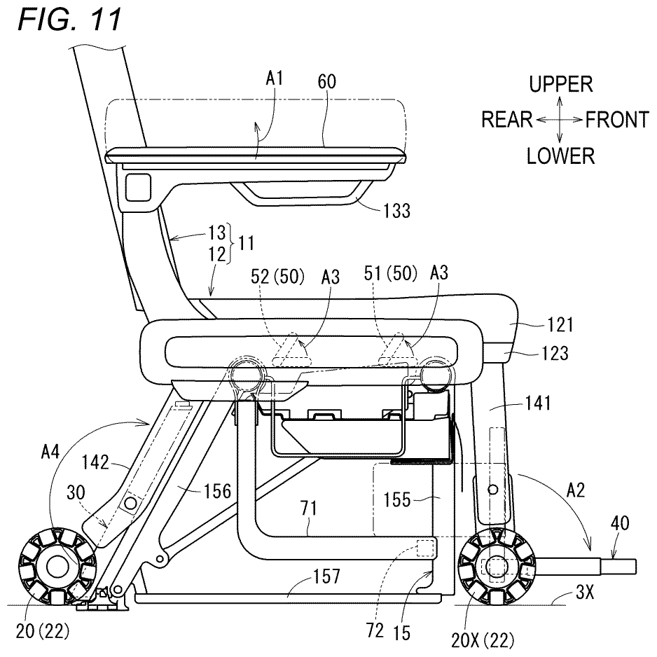

Next, in the seat device 10 illustrated in FIG. 1, the seat main body 11 with the wheels 20 (20X) can be moved to the other location in a procedure (example) to be described later. Here, in the configuration of the seat section 9 illustrated in FIG. 1, the seat main body 11 on the passage side is first moved, and then the seat main body on the window side is moved substantially in the same procedure as illustrated in FIG. 10. Therefore, the procedure (example) of moving the seat main body 11 disposed in the seat space to the other location will be described in detail below with reference to FIGS. 10 and 11 and the like. The following movement work can be performed in either a state in which no seated person (cared person) is seated on the seat main body 11 or a state in which the seated person is seated on the seat main body 11. The movement work can also be performed by passengers in the vehicle 2, such as cabin crew, staff, or other seated persons (caregivers).

With reference to FIGS. 10 and 11, when the seat main body 11 on the passage side is first moved, the left and right plate-shaped members 60 are displaced to the retraction posture to reduce a width dimension W of the seat main body 11 (see an arrow A1 in FIG. 11). Accordingly, when the seat main body 11 being moved is less likely to interfere with another structure of the vehicle interior 3, side portions of the seated person can be supported by the upright plate-shaped members 60. Next, the left and right foot steps 40 are displaced to footrest positions, so that the feet of the seated person can be supported (see an arrow A2 in FIG. 11). The seat cushion 12 is then raised by the operation of the lifter mechanism 50 (see an arrow A3 in FIG. 11). Accordingly, the coupling protrusion portion 82 on the seat cushion 12 side illustrated in FIG. 9 is removed from the coupling hole portion 81 on the support portion 15 side, and the coupling between the seat cushion 12 and the support portion 15 can be released. With reference to FIG. 11, the stopper 30 provided on the leg portion 14 is finally displaced from the stop posture to the retraction posture, so that the seat main body 11 is in a movable state (see an arrow A4 in FIG. 11).

Therefore, the seat main body 11 illustrated in FIG. 10 is horizontally moved inward in the width direction of the vehicle 2 along the support portion 15 by the operation of the wheels 20 and 20X (omnidirectional wheels) each including the movement mechanisms 22 (see an arrow A5 in FIG. 10). At this time, by using the grip portion 133 as a handle, the seat main body 11 can be more easily moved horizontally toward a passage portion 4 side. After the seat main body 11 is disposed on the passage portion 4, the lifter mechanism 50 is operated to tilt the links 51 and 52, whereby the seat cushion 12 is lowered to an original height position. The seat main body 11 in this state can be moved to the other location by traveling along the passage portion 4. In the same procedure, the seat main body 11 of the seat space 8 on the window side can also be moved to the passage portion 4.

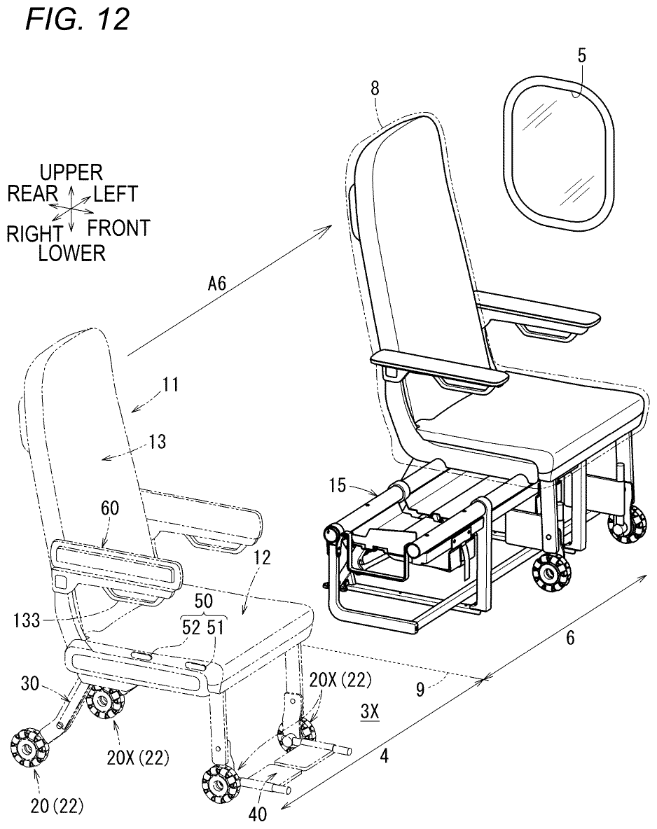

Next, with reference to FIG. 12, a procedure of causing the seat main body 11 returned from the other location to move from the passage portion 4 to a desired seat space will be described. In the configuration of the seat section 9, the seat main body 11 is first moved to the seat space 8 on the window side. At this time, in the state in which the seat main body 11 is disposed on the passage portion 4, the seat cushion 12 is raised by the operation of the lifter mechanism 50 so as not to interfere with the support portion 15 (see FIG. 3). Subsequently, the seat main body 11 is horizontally moved outward in the width direction of the vehicle 2 (left side in each of the drawings, see an arrow A6 in FIG. 12) along the support portion 15 by the operation of the wheels 20 and 20X (omnidirectional wheels) each including the movement mechanisms 22. Accordingly, the seat main body 11 can be disposed in the seat space 8 on the window side while being smoothly moved horizontally in the width direction of the vehicle 2.

With reference to FIG. 2, the lifter mechanism 50 is operated to tilt the links 51 and 52, whereby the seat cushion 12 is lowered to the original height position. Accordingly, the coupling protrusion portion 82 is inserted into the coupling hole portion 81 of the support portion 15 illustrated in FIG. 9, and the seat cushion 12 is coupled to and supported by the support portion 15 from above and below. As illustrated in FIG. 2, by displacing the stopper 30 from the retraction posture to the stop posture, the seat main body 11 can be positioned and disposed in the seat space 8 on the window side. Subsequently, the left and right foot steps 40 are returned to retraction positions, and the left and right plate-shaped members 60 are displaced from the retraction posture to the deployed posture. In the same procedure, the seat main body 11 can also be disposed in the seat space 7 on the passage side illustrated in FIG. 1.

According to the above configuration, in the vehicle 2 (passenger aircraft) illustrated in FIG. 1, the seat main body 11 itself can be moved to another location, for example, a passenger gate according to a demand of the seated person. After the seated person is seated on the seat main body 11 at the passenger gate, the seated person can directly access a desired seat space through the passage portion 4. Accordingly, when the seated person desires a seat on the window side, the seat main body 11 can be easily guided to the seat space 8 on the window side. In addition, while the vehicle 2 is in flight, the seat main body 11 itself on which the seated person is seated can be moved back and forth between the seat space and a lavatory (the other location), and a physical burden on the seated person (such as the cared person or the caregiver) can be reduced. In this way, according to the above configuration, the seated person who requires the seat main body 11 can enjoy the flight by, for example, reducing a time and effort during the movement. In the seat device 10 of the present embodiment, the seat main body 11 itself can be moved, and thus usability during movement can be ensured.

As described above, in the present embodiment, the support portion 15 that supports the seat main body 11 is provided below the seat cushion 12, that is, a location different from the seat space in which the seat cushion 12 and the like are disposed. Therefore, the seat main body 11 can be disposed such that the seat cushion 12 and the seat back 13 occupy the seat space, and can be used in the same manner as a normal seat. In the above device configuration, the seat main body 11 with the wheels 20 can be moved to the other location by detaching the seat cushion 12 from the support portion 15, and thus no large-scale equipment is required. In particular, in the present embodiment, the seat main body 11 can be disposed in a desired seat space by being horizontally moved along the support portion 15 with the operation of the movement mechanism 22. Therefore, according to the present embodiment, the seat main body 11 itself can be moved between the seat space and the other location without requiring large-scale equipment.

In the present embodiment, the seat cushion 12 is moved up and down by the operation of the lifter mechanism 50, so that the seat cushion 12 can be brought into a coupling state or a released state with the support portion 15. Further, in the present embodiment, when the seat main body 11 is disposed in the seat space, an object can be placed on the plate-shaped member 60 in the deployed posture, which contributes to ensuring convenience. By bringing the plate-shaped member 60 into the retraction posture, a dimension in the seat width direction of the seat main body can be reduced when the seat main body 11 is moved. In the present embodiment, the upper layer cushion portion 121 can be attached to and detached from the seat cushion 12, which contributes to securing convenience. In the present embodiment, the accommodation space portion 70 is provided in the support portion 15 below the seat cushion 12 in a state in which the seat main body 11 is disposed in the seat space, which further contributes to securing convenience. In the present embodiment, the seat main body 11 can be more easily horizontally moved by the grip portion 133.

The seat device of the present embodiment is not limited to the above embodiment, and various other embodiments are possible. In the present embodiment, an example of the lifter mechanism has been described. The lifter mechanism can be provided in at least one of the seat main body and the support portion, and for example, the upper support column portion can be moved up and down by the lifter mechanism provided in the support portion. The upper support column portion (one) is raised by the operation of the lifter mechanism and coupled to the seat cushion (the other), and is lowered by the operation of the lifter mechanism to release the coupling with the seat cushion. The configuration of the coupling mechanism may also be appropriately changed, and for example, the coupling hole portions can be provided on a seat cushion side, and the coupling protrusion portions can be provided on a support portion side. An engagement or fitting configuration can be adopted as a detachable coupling mechanism, and for example, an engaging portion provided in a visible location on the seat cushion can be engaged with an engaged portion of the support portion in the up-down direction and the like and coupled to each other.

The seat main body can be provided with the wheels at appropriate positions, and the wheels include structures such as caterpillars. The number of wheels can also be appropriately selected according to the configuration of the seat main body, and various configurations such as a four-wheel configuration or a three-wheel configuration can be adopted. In the present embodiment, the example in which the movement mechanisms are provided in the wheels of the seat main body has been described, but the movement mechanism may be provided in the support portion. For example, a rail portion is fixed as a movement mechanism on an upper side of the support portion so as to extend in the width direction. The seat cushion is slidably coupled to the rail portion, and thus the seat main body can be moved horizontally along the support portion. At this time, the support portion may be raised to cause the seat main body floating from the floor portion to move horizontally. In the above device configuration, the rail portion may be provided only in the support portion, and thus it is not necessary to introduce the large-scale equipment into the floor portion or the like in the vehicle interior.

The configuration of the seat cushion, the seat back, or the leg portion can be appropriately changed, and the configurations of the upper layer cushion portion (cushion portion), the stopper, the foot step, the plate-shaped member, and the grip portion, which are the related configurations, can be appropriately selected. For example, the upper layer cushion portion and the lower layer cushion portion can be provided in at least one of the seat cushion and the seat back, and the upper layer cushion portion can be provided in a state in which the upper layer cushion portion is detachable or non-detachable from the lower layer cushion portion. The stopper can be provided on at least one of the front leg portions and the rear leg portions, and can have various configurations such as a vertically pivotable type and a liftable type. In addition, the configuration of the foot step can also be appropriately changed, and for example, the foot step can be a vertically pivotable type having substantially the same configuration as the stopper. The foot step, which has substantially the same configuration as the stopper, is pivotally supported on the front leg portion so as to be vertically pivotable. The foot step is brought into a footrest posture by performing pivoting downward, and the foot step is retracted on the seat cushion side by performing pivoting upward. When the foot step and the stopper having substantially the same configuration are provided for the front leg portion, the foot step and the stopper may be interlocked. In this case, the foot step is brought into the footrest posture when the stopper is in the retraction posture, and the foot step is retracted on the seat cushion side when the stopper is in the stop posture. The plate-shaped member may be provided on the support portion rather than on the seat main body. The grip portion can be provided on at least one of the seat cushion and the seat back.

The configuration of the support portion can also be changed appropriately, and the configuration of the accommodation space portion, which is a related configuration, can also be selected appropriately. For example, the support portion may be provided for each of the seat spaces, or may be provided across three or more seat spaces. When the support portion is provided for each of the seat spaces, the seat space in which the seat main body is disposed and the seat space in which no seat main body is disposed may be adjacent to each other. In such a case, in the seat space in which no seat main body is disposed, for example, a height dimension of the support portion may be reduced by the operation of the lifter mechanism. Accordingly, a space (free space or storage space) formed by lowering the support portion can be secured at a position adjacent to the seat main body. In addition, a rotation table may be disposed on the support portion. The orientation of the seat main body can be changed by the operation of the rotation table, and for example, the seat main body can be changed from the rear to the front (normal posture illustrated in FIG. 1). In the present embodiment, a movement procedure of the seat main body is exemplified, but the order of moving the members and the like can be appropriately changed, and it is not necessary to move all the members. For example, when the seat main body is moved, the plate-shaped members may be in the deployed posture, and in this case, the arms of an occupant can be supported by the plate-shaped members when the seat main body is moved. In addition, in the seat main body disposed in the seat space, the feet of the occupant can be supported by the foot step in the footrest posture. The configuration of the present embodiment can be applied to all seats of a vehicle (welfare vehicle or the like), a train, a ship, and the like, in addition to an aircraft such as a passenger aircraft, and can also be applied to all seats arranged in a building such as a commercial facility or a public facility.

What is claimed is:

1. A seat device in which a seat main body provided with a seat cushion serving as a seat portion and a seat back serving as a backrest is arranged in a seat space set at a predetermined arrangement location, the seat device comprising:
wheels configured to allow the seat main body to travel, and a support portion configured to support the seat main body,
wherein the support portion is disposed at the arrangement location so as to be disposed below the seat cushion, and the seat main body occupies the seat space by the seat cushion being detachably coupled to and supported by the support portion.

2. The seat device according to claim 1, further comprising:
a lifter mechanism configured to displace one of the seat cushion and the support portion between a coupling state in which the one of the seat cushion and the support portion is moved up and down to be coupled to the other and a released state in which the one of the seat cushion and the support portion is separated from the other to release the coupling.

3. The seat device according to claim 1,
wherein the seat back includes a base portion fixed to a side portion in a seat width direction thereof, and a plate-shaped member attached to the base portion via a hinge portion, and
wherein the plate-shaped member is displaceable between a deployed posture in which the plate-shaped member is tilted outward in the seat width direction and a retraction posture in which the plate-shaped member stands in a seat upper direction by a raising and tilting operation with the hinge portion as a base point.

4. The seat device according to claim 1,
wherein a cushion portion that elastically supports a seated person is detachably attached to a seating surface side of the seat cushion.

5. The seat device according to claim 1,
wherein the support portion in a state of supporting the seat cushion is provided with an accommodation space portion having a predetermined capacity so as to communicate with an outside.

6. The seat device according to claim 1,
wherein the support portion extends in a width direction across a plurality of the seat spaces arranged side by side, and includes a movement mechanism that causes the seat main body, which is released from the coupling with the support portion, to horizontally move in the width direction along the support portion.

7. The seat device according to claim 6,
wherein the seat main body is provided with a grip portion, which serves as a handle during movement of the seat main body, on an end portion side in a seat width direction.
